(19) United States
(12) Patent Application Publication
(10) Pub. No.: US 2023/0361581 A1
(43) Pub. Date: Nov. 9, 2023

(54) INTEGRATED CONTROL AND MONITORING OF ULTRACAPACITOR CHARGING AND CELL BALANCING

(71) Applicant: UCAP POWER, INC., San Diego, CA (US)

(72) Inventors: Carl David Wright, San Diego, CA (US); Joshua Hitt, Redmond, WA (US); Troy Brandon, San Diego, CA (US); Tyler Warner Gilbert, Draper, UT (US)

(21) Appl. No.: 18/245,535

(22) PCT Filed: Sep. 15, 2021
(86) PCT No.: PCT/US2021/050535

§ 371 Date: Mar. 15, 2023

Related U.S. Application Data
(60) Provisional application No. 63/079,830, filed on Sep. 17, 2020.

(51) Int. Cl. H02J 7/00; H02J 7/34

(52) U.S. Cl. CPC H02J 7/0016; H02J 7/345

(57) ABSTRACT

Systems and methods for integrated control and monitoring of charging and cell balancing in a group of ultracapacitors. Monitoring and control circuitry can be configured for built-in monitoring feedback to the charger and the balancing circuits to dynamically improve performance, extend system lifetime, decrease charging time, increase available power and/or energy, and/or enhance safety and reliability of the group of ultracapacitors.

### CROSS-REFERENCE TO RELATED APPLICATIONS

This application is the U.S. National Phase of PCT/US2021/050535, filed Sep. 15, 2021, titled “Integrated Control and Monitoring of Ultracapacitor Charging and Cell Balancing,” which claims priority to U.S. Provisional Application Ser. No. 63/079,830, filed Sep. 17, 2020, titled “Integrated Control & Monitoring of Ultracapacitor Charging and Cell Balancing,” the entirety of which is incorporated by reference herein.

### FIELD

The present technology relates generally to systems for integrated control and monitoring of chargeable cells, and more specifically to charging and cell balancing of ultracapacitors.

### BACKGROUND

Many modern electronic systems require efficient energy storage and charging solutions. Energy storage allows the creation of sustainable energy systems. Electronic devices, which have become ubiquitous in modern society, are heavily reliant on energy storage technologies. The breadth of products and industries which energy storage affects demonstrates how valuable advances and breakthroughs in this field have become.

Ultracapacitors, also known as “supercapacitors” or “electric double-layer capacitors” (referred to hereafter as “UCAPs”), have emerged with the potential to supplement or even replace batteries in many energy storage applications. UCAPs store energy differently than batteries. More specifically, energy is stored electrostatically in UCAPs on the surface of the electrode and does not involve the same type of chemical reactions which occur in batteries. UCAPs are governed by the same fundamental equations as conventional capacitors, however they utilize substantially higher surface area electrodes due to the nano-porous nature of activated carbon. UCAPs also make use of atomic and molecular dipole moments, which act as virtual atomic layer dielectrics to achieve greater capacitances. This results in UCAP energy densities that are greater than those of conventional capacitors along with power densities that are greater than those of available batteries. Given their fundamental mechanism, UCAPs have advantages over batteries in terms of power density, charge and discharge rates, operating life, cycle life, temperature performance, chemical stability, and reliability. For example, UCAPs can perform one million or more charge/discharge cycles with predictable aging characteristics. As a result, UCAPs have increasingly become an attractive power solution in many different applications that require relatively large or frequent bursts of electrical power.

### SUMMARY

For purposes of summarizing the present technology and the advantages achieved over existing technology, certain objects and advantages are described herein. Of course, it is to be understood that not necessarily all such objects or advantages need to be achieved in accordance with any particular embodiment. Thus, for example, those skilled in the art will recognize that the present technology may be embodied or carried out in a manner that can achieve or optimize one advantage or a group of advantages without necessarily achieving other objects or advantages.

In a first aspect, an ultracapacitor system comprises a plurality of ultracapacitor cells connected in series; a charger electrically connected to at least one of the plurality of ultracapacitor cells; a plurality of balancing circuits, each balancing circuit being electronically switchable between an activated state in which a corresponding ultracapacitor cell of the plurality of ultracapacitor cells discharges through the balancing circuit and a deactivated state in which the corresponding ultracapacitor cell does not discharge through the balancing circuit; and controller circuitry in communication with the charger and the plurality of balancing circuits.

In some embodiments, the controller circuitry is configured to control, during a charging operation, a charge current applied by the charger to charge the plurality of ultracapacitor cells. In some embodiments, the controller circuitry is configured to control the charge current to maintain a constant-current charging mode during at least a portion of the charging operation. In some embodiments, the controller circuitry is configured to control the charge current to maintain a constant-power charging mode during at least a portion of the charging operation. In some embodiments, in the constant-power charging mode, the controller circuitry controls the charge current such that an output power of the charger is maintained at a charge power selected based at least in part on a detected temperature associated with the ultracapacitor system. In some embodiments, the controller circuitry is configured to derate the charge power using a power derating factor when the detected temperature exceeds a predetermined power derating temperature. In some embodiments, the controller circuitry is further configured to control the charge current based at least in part on an end-of-charge voltage of the plurality of ultracapacitor cells. In some embodiments, the controller circuitry is further configured to determine the end-of-charge voltage based at least in part on a detected temperature associated with the ultracapacitor system.

In some embodiments, the controller circuitry is configured to individually activate each of the plurality of balancing circuits. In some embodiments, the controller circuitry is configured to activate one or more of the balancing circuits to lower an overall voltage of the plurality of ultracapacitor cells based at least in part on a detected temperature exceeding a threshold. In some embodiments, the controller circuitry is configured to individually activate one or more of the plurality of balancing circuits to implement a cell balancing operation. In some embodiments, the cell balancing operation is based at least in part on a lowest cell voltage of a plurality of cell voltages corresponding to the individual ultracapacitor cells. In some embodiments, during the cell balancing operation, the controller circuitry activates the balancing circuits corresponding to each of the ultracapacitor cells having a cell voltage greater than the lowest cell voltage. In some embodiments, during the cell balancing operation, the controller circuitry activates the balancing circuits corresponding to each of the ultracapacitor cells having a cell voltage exceeding the lowest cell voltage by at least a predetermined voltage difference. In some embodiments, the cell balancing operation is based at least in part on an average cell voltage of a plurality of cell voltages corresponding to the individual ultracapacitor cells. In some embodiments, during the cell balancing operation, the controller circuitry activates the balancing circuits corresponding to each of the ultracapacitor cells having a cell voltage greater than the average cell voltage. In some embodiments, the controller circuitry implements the cell balancing operation in response to a determination that an overall voltage of the plurality of ultracapacitor cells is greater than or equal to a predetermined balancer start voltage. In some embodiments, the controller circuitry is configured to implement the cell balancing operation while the charger is charging the plurality of ultracapacitor cells. In some embodiments, the controller circuitry implements the cell balancing operation only once per charge cycle of the ultracapacitor system.

In some embodiments, each balancing circuit comprises a discharge resistor connected in parallel with the corresponding ultracapacitor cell. In some embodiments, each balancing circuit further comprises a balancing transistor connected in parallel with the corresponding ultracapacitor cell, the balancing transistor having a gate connected to an output of the controller circuitry. In some embodiments, the system further comprises a redundant transistor electrically connected between the charger and the plurality of ultracapacitor cells, the redundant transistor controllable by the controller circuitry to prevent overcharging of the plurality of ultracapacitor cells.

In some embodiments, the controller circuitry is configured to transmit monitoring data to a remote computing device via wired or wireless connection for system monitoring.

In a second aspect, a computer-implemented method of charging an array of ultracapacitor cells comprises, under control of controller circuitry of an ultracapacitor system, controlling a charger in communication with the controller circuitry to supply a charge current to a plurality of ultracapacitor cells and activating at least one of a plurality of balancing circuits, while the charger supplies the charge current, to implement a cell balancing operation, wherein each of the plurality of balancing circuits is electronically switchable between an activated state in which a corresponding ultracapacitor cell of the plurality of ultracapacitor cells discharges through the balancing circuit and a deactivated state in which the corresponding ultracapacitor cell does not discharge through the balancing circuit.

In some embodiments, controlling the charger comprises causing the charger to charge the plurality of ultracapacitor cells at a constant current.

In some embodiments, controlling the charger comprises causing the charger to charge the plurality of ultracapacitor cells at a constant power. In some embodiments, the constant power is selected based at least in part on a detected temperature associated with the ultracapacitor system. In some embodiments, the constant power is derated using a power derating factor when the detected temperature exceeds a predetermined power derating temperature.

In some embodiments, the cell balancing operation is based at least in part on a lowest cell voltage of a plurality of cell voltages corresponding to the individual ultracapacitor cells. In some embodiments, activating at least one of the balancing circuits comprises activating the balancing circuits corresponding to each of the ultracapacitor cells having a cell voltage greater than the lowest cell voltage. In some embodiments, activating at least one of the balancing circuits comprises activating the balancing circuits corresponding to each of the ultracapacitor cells having a cell voltage exceeding the lowest cell voltage by at least a predetermined voltage difference.

In some embodiments, the cell balancing operation is based at least in part on an average cell voltage of a plurality of cell voltages corresponding to the individual ultracapacitor cells. In some embodiments, activating at least one of the balancing circuits comprises activating the balancing circuits corresponding to each of the ultracapacitor cells having a cell voltage greater than the average cell voltage.

In some embodiments, the controller circuitry implements the cell balancing operation in response to a determination that an overall voltage of the plurality of ultracapacitor cells is greater than or equal to a predetermined balancer start voltage.

In some embodiments, the controller circuitry implements the cell balancing operation only once per charge cycle of the ultracapacitor system.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an electronic schematic which illustrates an example implementation of a passive balancing system.

FIG. 2 is an electronic schematic which illustrates an example implementation of an active balancing system.

FIG. 3 is an electronic schematic which illustrates an example balancing system in which each cell voltage is monitored by a microcontroller, and the charger current and the state of each individual balancing transistor is continuously monitored and controlled by the same microcontroller.

FIG. 4 is a block diagram schematically illustrating an example system for managing a group of ultracapacitors.

The figures are not intended to be exhaustive or to limit the present disclosure to the precise form disclosed. It should be understood that the present technology can be practiced with modification and alteration, and that the present technology should be limited only by the claims and the equivalents thereof.

### DETAILED DESCRIPTION

Although certain embodiments and examples are described below, those of skill in the art will appreciate that the present technology extends beyond the specifically disclosed embodiments and/or uses and obvious modifications and equivalents thereof. Thus, it is intended that the scope of the present technology herein disclosed should not be limited by any particular embodiments described below.

Typical UCAP systems as described herein may be implemented to generally include an array of individual UCAP cells, a set of active or passive cell balancing components, and a charging mechanism. In conventional implementations, the charging mechanism is typically separately packaged relative to cell balancing components.

Balancing of the cells within a system plays an important role for a number of reasons. For example, balancing may ensure that the overall capacity of the system is not limited by the lowest State of Charge (SoC) cell in an array, prior to discharge. A balanced cell array thus increases the relative overall capacity compared to an unbalanced implementation, enabling increased power and energy availability to the system.

In another example, balancing of cells within a system or array may ensure that the stress, and hence the lifetime, of each cell is uniform, resulting in the longest overall system life. Increased lifetime improves user Return on Investment (RoI) by reducing replacement costs, maintenance costs, and downtime.

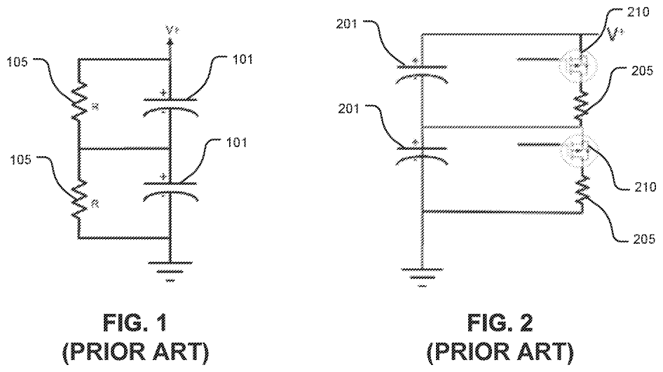

Balancing mechanisms typically fall into two categories: passive (full-time resistive) and active (electronically switched) balancing. Passive balancing may be effective in some situations, but the full-time current load of the balancing resistors means that the UCAPs will discharge to zero volts without being periodically recharged. Active systems are typically threshold-based and are enabled only when the system is at or near 100% SoC. Example implementations are shown in FIG. 1 and FIG. 2.

The passively balanced system of FIG. 1 includes a plurality of UCAPs 101 connected in series and corresponding resistors 105 having a resistance value R. In the passively balanced system of FIG. 1, the resistance values of the resistors 105 are typically chosen so that the current through the resistors 105 at the rated system voltage are 10-20 times larger than the expected leakage current of the UCAPs 101. This ensures that over a sufficient time frame, the resistor network has the primary influence on cell voltage versus the individual cell leakage, resulting in a balanced UCAP array. As previously stated, this results in the array having continual energy loss and eventual full discharge of the cells without recharging. The system effect of a passively balanced UCAP array results in wasted energy due to the constant discharge through the balancing resistors 105. Furthermore, the likelihood of not having sufficient power to meet the system needs greatly increases without a periodic or constant recharging scheme, thereby adding costs and decreasing system reliability.

The active balanced system of FIG. 2 includes a plurality of UCAPs 201 connected in series and corresponding resistors 205 and transistors 210, such as field effect transistors or the like. In the active balanced system, FIG. 2, each of the transistors 210 is activated when the voltage across the corresponding UCAP 201 is determined to be higher than desired, typically by comparing it to a fixed reference voltage equal to the desired steady-state voltage of the UCAPs 201. The active approach improves the continual energy loss of the passive approach, and the resistors 205 are typically sized so that the system can be balanced more quickly at the desired operating point. However, the fixed value of the reference voltage means that balancing may only occur above set voltage points, resulting in potential overall capacity loss during the charge cycle due to imbalance. Above the balancing set voltage point the UCAP array capacity will normalize to a balanced state. In a situation where there is a system discharge event that drops the voltage below the balancing set point followed by a second discharge event prior to the array being recharged above the balancing set point the system will be unbalanced and susceptible to the deficiencies noted above. Additionally, many threshold-based actively balanced UCAP arrays may increase the total charge time to reach the desired voltage due to their implementation, this potentially results in not having sufficient power to meet the system requirements when needed.

When the charging mechanism is separate from the ultracapacitor array with its associated balancing system, charging and balancing are, by necessity, decoupled. This narrows the range of control strategies available, as both the charging subsystem and the balancing subsystem must work independently. For example, a UCAP Charger manufacture needs to design to the generic characteristics of a UCAP array, limiting the ability to synergize and create an optimized performance and total cost system or to mitigate any unique disadvantages within the charger and/or the UCAP array subsystem.

### Processor-Controlled Integrated Charging and Balancing Systems

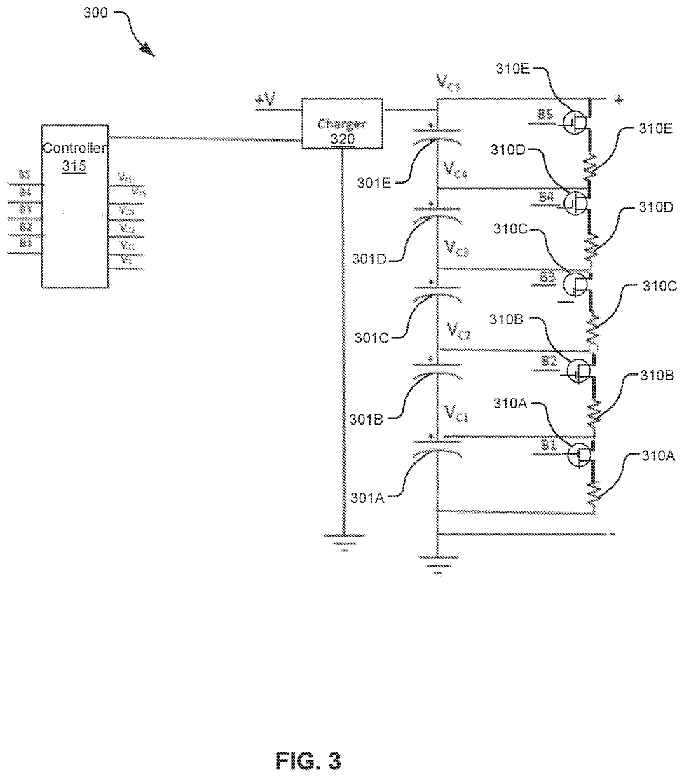

In some aspects of the present technology, charging and balancing systems of a UCAP array are integrated with a processor-controlled system as shown in the simplified block diagram of FIG. 3.

FIG. 3 illustrates an ultracapacitor system 300 which comprises a string of UCAPs 301A, 301B, 301C, 301D, 301E configured for integrated control and monitoring of charging and cell balancing. The system of FIG. 3 further includes a corresponding resistor 305A-305E and a corresponding transistor 310A-310E, respectively, for each UCAP 301A-301E. In a system configured as shown in FIG. 3, each cell voltage V_{C1}-V_{C5}, corresponding to UCAPs 301A-301E, respectively, may be monitored by a controller 315, and the charger current applied by a charger 320 and the state of each individual balancing transistor 310A-310E can be continuously monitored and controlled by the same controller 315. Of course, it should be realized that the controller 315 can be any well-known type of processing unit, such as a microcontroller, central processing unit (CPU), or other processor. Additional supporting circuits, such as a thermistor or a microprocessor with a built-in temperature measurement feature and/or a memory function to enable real-time logging of circuit performance, may also be used within the system 300 as part of the monitoring and control solution. In some embodiments, the system 300 may further include a redundant transistor suitable for preventing overcharging in the event of a failure of the corresponding transistor 310A-310E. For example, the redundant transistor can be in a normally on configuration and may be selectively switchable to prevent overcharging of the UCAPs 301A-301E under control of the controller 315. In some embodiments, the redundant transistor can be disposed between the charger 320 and the UCAPs 301A-301E.

When the system is implemented as shown in FIG. 3, the performance of the system can be optimized through active management by software executed by the controller 315. This integration can enable different charging and control strategies that provide specific benefits in various applications and to overall system performance.

Besides enabling automated or “smart” charging processes within the integrated UCAP/charger system 300, these unique monitor values can be transmitted to a remote collection facility via any wired or wireless means where they can be statistically analyzed for anomalies, near End of Life (EoL) risks, or design improvements. To the end user and supplier of the UCAP array this information can be used to selectively plan maintenance/upgrade schedules minimizing down time on mission critical applications such as wind turbines or back-up generators, reducing the total cost of ownership and maximizing revenue generating applications.

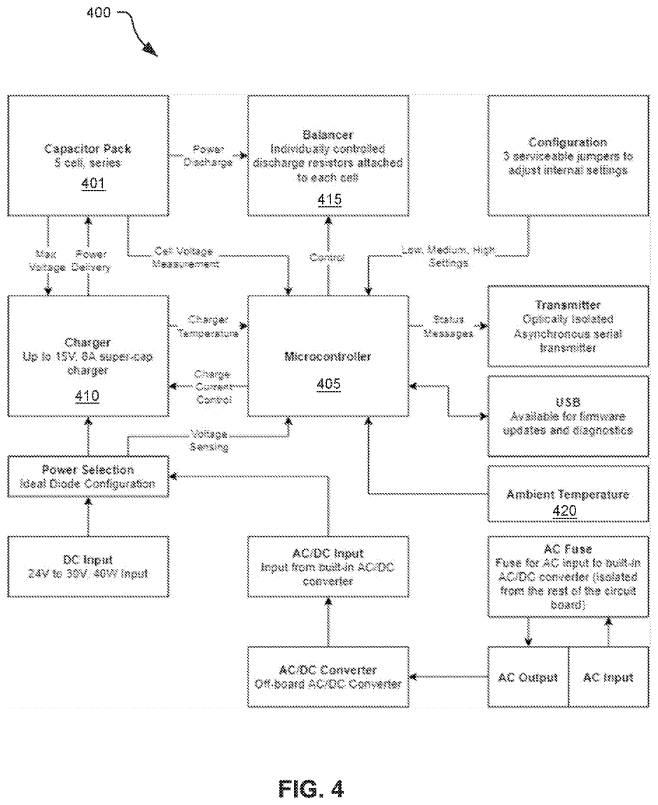

FIG. 4 is a block diagram illustrating a further example system 400 for managing an array of ultracapacitors in a capacitor pack 401 under control of a microcontroller 405. The system further includes a charger 410 and a balancer 415 each connected to, and configured to be controlled by, the microcontroller 405. At least one ambient temperature sensor 420 can be included and may provide to the microcontroller 405 ambient temperature measurements at one or more locations within the system.

The capacitor pack 401 may include, for example, a series string of UCAPs such as UCAPS 301A-301E illustrated in FIG. 3, or any other grouping of UCAPs connected in series, parallel, or combination of series and parallel connections. Although the capacitor pack 401 includes five cells in series, it will be understood that any array of 2 or more cells may be included. For example, in some embodiments the microcontroller 405 is in communication with and configured to control two or more parallel strings of cells, each string including a plurality of cells connected in series. Similar to the configuration illustrated in FIG. 3, the capacitor pack 401 is configured to send cell voltage measurements to the microcontroller 405, and may send individual voltage measurements for each cell, and/or full pack or string voltage measurements of a voltage across the full string or pack, to the microcontroller 405 on a continuous or periodic basis.

The charger 410 is in communication with a power source which may include one or more components such as power selection, DC input, AC/DC input, AC/DC converter, one or more fuses, and the like. The charger 410 is in communication with the microcontroller 405 and may transmit data such as charger temperature measurements to the microcontroller 405. The microcontroller 405 may control the charger 410 to begin and terminate charging, and/or may control the charge current delivered by the charger 410 to the capacitor pack 401. The charger 410 is electrically connected to the capacitor pack 401 to deliver charge current to the string or strings of cells within the capacitor pack 401, and may further receive signals from the capacitor pack such as, for example, one or more voltage measurements such as a full pack voltage or the like.

The balancer 415 includes a plurality of individually controlled discharge resistors connected across each cell within the capacitor pack 401. For example, in a system including the configuration of FIG. 3, the balancer 415 may include discharge resistors 305A-305E and transistors 310A-310E, such that a balancing discharge from any individual UCAP 301A-301E can be controlled individually by activating the corresponding transistor 310A-310E. Thus, the balancer 415 can be controlled by one or more control signals from the microcontroller 405, and may accordingly receive power discharged from the capacitor pack 401.

### Processor-Controlled Integrated Charging and Balancing Methods

With joint reference now to FIGS. 3 and 4, several non-limiting example charge and balancing control and/or monitoring processes will now be described. Although the following control and/or monitoring processes are described with reference to the components illustrated in the example configurations of FIGS. 3 and 4, such processes are not limited to the configurations of FIGS. 3 and 4 and may be implemented in other systems without departing from the scope of the present technology.

In various embodiments, the control and monitoring systems of the present technology such as the system of FIGS. 3 and 4 can be operable in several modes, such as an active charge and balance mode, an idle mode, and an error mode. In the active charge and balance mode the controller (e.g., controller 315 or microcontroller 405) is active and the UCAPs are being charged under control of the controller (e.g., during a charge and balance cycle). In the idle mode, the controller is not causing the charger 410 and/or balancer 415 to charge and/or balance the capacitor pack 401. One or more error modes may prevent charging and/or balancing, as will be described in greater detail.

The microcontroller 405 may transition the system from the idle mode to the active charge and balance mode based on one or more signals received from the capacitor pack 401. For example, the microcontroller 405 may receive a pack or string voltage measurement from the capacitor pack 401 indicating that the pack or a string within the pack has a total voltage below a charging initiation threshold. Based on the same voltage measurements, the microcontroller 405 may transition the system back to the idle mode when the pack or string voltage reaches an end charging threshold.

In one example active charge and balance process, systems in accordance with the present technology may be configured to implement constant-power or constant-current charging. During a charging event, the microcontroller 405 monitors and controls the charging current applied to the capacitor pack 401 from the charger 410. In a constant-current charging process, the desired current is output to a microcontroller pulse-width modulated (PWM) output, which may further be sent to a low-pass filter. The average value of the PWM signal may be routed to the current set input of the charger 410. Advantageously, the control of charge current using a PWM signal may allow variable control of the charge current at minimal expense.

Alternatively, the output power (e.g., charger output voltage x charger output current) may be controlled and kept constant during charging. In one example method, the microcontroller 405 initially causes charging at a constant current until the output power reaches a desired constant charge power due to increasing voltage. After the desired charge power is reached, the microcontroller 405 causes the charger 410 to reduce the charge current so as to maintain a constant power charge while avoiding exceeding power supply maximum current restrictions. The constant power profile results in faster charging thereby enabling more system up time and faster recovery.

Constant-power and/or constant-current charging modes may additionally facilitate in-situ measurement of capacitance of a pack, string, or individual cells of a UCAP array. In either constant-current or constant-power charging mode, the time between two specified voltage points will be a function of the array capacitance. This time can be logged by the system (e.g., by the microcontroller 405 in conjunction with any storage medium in communication therewith) and used to accumulate performance data on how the capacitance varies as the system ages, and/or may be shared via a wired or wireless method to an external monitoring system. Real-time visibility and access to unique UCAP array data enables an optimized maintenance and upgrade schedule greatly lowering total cost of ownership and increased uptime. The unique UCAP array performance data enables automatic charging profile adjustments as the system ages extending performance, increasing system lifetimes, and improving long-term reliability.

In some embodiments, the microcontroller 405 is further configured to limit charge current based on the ambient temperature, such as based on temperature measurements received from the ambient temperature sensor 420. For example, the microcontroller 405 may store a low power derating temperature and a high power derating temperature. If the ambient temperature measurement received from the ambient temperature sensor 420 exceeds the low power derating temperature during charging, the charge power (e.g., as controlled using the constant-power charging method described above) can be linearly reduced by a power derating factor. If the ambient temperature measurement exceeds the high power derating temperature, charging may be discontinued.

In some embodiments, a single set UCAP array can be optimized for multiple applications by implementing a flexible end-of-charge voltage. For example, a higher end-of-charge voltage may be desired to obtain maximum power/energy performance. A lower end-of-charge voltage may be desirable to maximize cell lifetime. Thus, performance optimization based on an intended application enables product flexibility, lowering system costs and increasing efficiency.

In some embodiments, an end-of-charge voltage may be determined based on temperature. Increased temperature and voltage during charging and/or discharging may negatively influence the lifetime of ultracapacitor cells. Advantageously, in some implementations these effects can be offset or mitigated using the integrated control and monitoring systems and methods of the present technology. For example, at higher temperatures (e.g., higher ambient temperatures, or higher temperatures measured within the capacitor pack 401 and/or at the charger 410), the end-of-charge voltage may be reduced, improving cell lifetime. At lower temperatures, the end-of-charge voltage may be increased, improving the power and/or energy available.

### Example Cell Balancing Operations

Active balancing operations may be performed one or more times during a charge cycle. In some embodiments, the systems of the present technology may be configured to perform active balancing only once per charge cycle, so as to achieve advantageous improvements in the charge cycle as described herein while maintaining efficient charging operations and avoiding excessive discharge of power in balancing operations during charging. Generally, cell balancing during charge, rather than as a separate operation performed after charging, may be especially advantageous. For example, performing balancing to yield a balanced or substantially balanced array prior to being fully charged can result in faster charging and increased power availability as compared to existing cell balancing techniques.

In some embodiments, balancing operations may be initiated during a charge cycle based on a predetermined balancer start voltage. The predetermined balancer start voltage may correspond to a threshold pack or string voltage received at the microcontroller 405. When the pack or string voltage reaches the predetermined balancer start voltage, the microcontroller 405 may activate the balancer 415 to initiate cell balancing.

In one example balancing method, the balancer 415 and/or the microcontroller 405 finds the lowest cell voltage of the group (e.g., pack or string) of UCAPs being balanced/charged and compares the lowest cell voltage to the cell voltages of the other UCAPs in the group. If the difference between the lowest cell voltage and any other cell voltage exceeds a predetermined balancer delta high voltage, the balancer circuit is enabled for the higher-voltage cell (e.g., the transistor 310A-310E corresponding to the higher-voltage UCAP 301A-301E is activated). Once the difference is less than a predetermined balancer delta low voltage (e.g., a lower difference threshold than the balancer delta high voltage), balancing is disabled for the higher-voltage cell. Once the cell voltage of every actively balanced cell is within the balancer delta low voltage of the lowest cell voltage, balancing may be terminated until the next charge cycle. In some embodiments, the balancing operation may cease after a charging cycle terminates, even if the cells have not been balanced completely.

In another example balancing method, the balancer 415 and/or the microcontroller 405 may implement a pseudo-passive balancing mode. In the pseudo-passive balancing mode, the balancer 415 continuously cycles all balance circuits with a specified duty cycle over a repeating duty cycle period.

A variety of other balancing methods are possible as well. In one example, during balancing, the microcontroller 405 may determine an average voltage among all of the cells in the group of cells being balanced, and may activate the balancing circuit (e.g., by activating the corresponding transistor) for any cell with a voltage above the average voltage of all cells. Driving all cells to the average voltage of the array may improve the lifetime of the cells.

In another example, during balancing, the microcontroller 405 may determine a lowest voltage among all of the cells in the group of cells being balanced, and may activate the balancing circuit (e.g., by activating the corresponding transistor) for any cell with a voltage above the lowest cell voltage of all cells. Driving all cells to the lowest voltage of the array may similarly improve the lifetime of the cells.

In another example, during balancing, the microcontroller 405 may determine a cell voltage threshold based on a temperature measured within the capacitor pack 401 and/or based on an ambient temperature detected at the ambient temperature sensor 402. The cell voltage threshold may be determined based on a suitable temperature-dependent function as will be understood by those of ordinary skill in the art. The microcontroller 405 may activate the balancing circuit (e.g., by activating the corresponding transistor) for any cell with a voltage above the determined cell voltage threshold. Preventing any cell from reaching higher than a specified temperature-dependent voltage may improve overall reliability, lifetime, and safety conditions.

In another example, if the UCAP array experiences a significant increase in temperature or other extreme condition, the balance circuits can be activated simultaneously to uniformly reduce each cell to a non-critical condition (e.g., by reducing the charge level of each individual cell to a lower level during a high temperature event). This results in overall improved reliability, lifetime, and safety conditions.

### Error Monitoring and Error Modes

The integrated charging and balancing systems and methods described herein may further improve the reliability and/or safety of operation by detecting and addressing and/or mitigating a variety of error conditions. Example errors that may be detected in accordance with the presently disclosed systems and methods include high temperature errors, voltage input to pack short errors, cell over-voltage condition errors, voltage input under-voltage errors, and/or failure to charge errors.

A high temperature error may be detected and/or mitigated by the microcontroller 405 based on a charger temperature measurement received from the charger 410 and/or based on an ambient temperature received from the ambient temperature detector 420. For example, the microcontroller 405 may compare a received charger temperature measurement to a predetermined charger fault temperature. In response, the microcontroller 405 may cause the charger 410 to pause charging of the capacitor pack 401 until a predetermined fault recover threshold is reached. For example, the predetermined fault recover threshold may correspond to an ambient temperature detected at the ambient temperature detector 420 and/or a charger temperature measurement, and may be lower than the charger fault temperature.

A voltage input to pack short may occur, for example, if the charging and balancing circuit suffers multiple component failures along the power delivery path from the charger 410 to the capacitor pack 401. Depending on the location of the short or other component failure(s), such a short may potentially allow one or more cells to overcharge to the point of failure, resulting in hazardous conditions such as the release of electrolytes. A voltage input to pack short error may be detected at the microcontroller 405 and/or at the charger 410 based on a determination that the input voltage is equal to the pack voltage while the pack voltage is above a charge inhibit voltage. In some cases, the hardware component failure may be detected when the pack voltage exceeds the charge inhibit voltage for at least a predetermined time period, such as 1 minutes, 2 minutes, 5 minutes, 10 minutes, or other appropriate time interval. In the event that a voltage input to pack short is detected, the microcontroller 405 may cause charger 410 to cease charging, such as by turning off a redundant transistor in the charging path between the charger 410 and the capacitor pack 401, and may further cause the balancer 415 to activate all of the balancing circuits (e.g., by activating all transistors 310A-310E in FIG. 3) so as to enable all of the balancing circuits to absorb a portion of the energy going into the capacitor pack 401.

A cell over-voltage condition error may be detected at the microcontroller 405 based on cell voltage measurements received from the capacitor pack 401, for example, when any individual cell voltage exceeds a predetermined cell over-voltage threshold. When a cell over-voltage condition is detected in any individual cell based on exceeding the predetermined cell over-voltage threshold, the microcontroller 405 or controller 315 may cause the balancer 415 to begin discharging the individual cell, and/or may cause the charger 410 to pause charging of the capacitor pack 401, thereby mitigating an over-voltage situation. For example, in the configuration of FIG. 3, if an over-voltage condition is detected based on V_{C3} exceeding the cell over-voltage threshold, the controller 315 may activate transistor 310C such that power is dissipated from UCAP 301C to mitigate the over-voltage.

A voltage input under-voltage error may occur due to a fault in the power supply to the charger 410. A voltage input under-voltage error may be detected at the microcontroller 405 and/or at the charger 410 when the input voltage drops below a predetermined minimum charge input voltage threshold. An input voltage below the predetermined minimum charge input voltage threshold may can cause the microcontroller 405 to prevent a charge cycle from starting or, if a charge cycle is in progress when the input voltage drops below the minimum charge input voltage threshold, the microcontroller 405 may cause the charger 410 to suspend charging until the voltage recovers.

A failure to charge error may be detected at the microcontroller 405 based upon a predetermined time limit (e.g., a charge error duration threshold) when the total charge time (e.g., a time elapsed since initiation of an active charge and balance mode) exceeds the charge error duration threshold. The microcontroller 405 may cause the charger 410 to cease charging.

### Additional Implementation Details

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An ultracapacitor system comprising:
a plurality of ultracapacitor cells connected in series;
a charger electrically connected to at least one of the plurality of ultracapacitor cells;
a plurality of balancing circuits, each balancing circuit being electronically switchable between an activated state in which a corresponding ultracapacitor cell of the plurality of ultracapacitor cells discharges through the balancing circuit and a deactivated state in which the corresponding ultracapacitor cell does not discharge through the balancing circuit; and
controller circuitry in communication with the charger and the plurality of balancing circuits.

2. The ultracapacitor system of claim 1, wherein the controller circuitry is configured to control, during a charging operation, a charge current applied by the charger to charge the plurality of ultracapacitor cells.

3. The ultracapacitor system of claim 2, wherein the controller circuitry is configured to control the charge current to maintain a constant-current charging mode during at least a portion of the charging operation.

4. The ultracapacitor system of claim 2, wherein the controller circuitry is configured to control the charge current to maintain a constant-power charging mode during at least a portion of the charging operation.

5. The ultracapacitor system of claim 4, wherein, in the constant-power charging mode, the controller circuitry controls the charge current such that an output power of the charger is maintained at a charge power selected based at least in part on a detected temperature associated with the ultracapacitor system.

6. The ultracapacitor system of claim 5, wherein the controller circuitry is configured to derate the charge power using a power derating factor when the detected temperature exceeds a predetermined power derating temperature.

7. The ultracapacitor system of claim 2, wherein the controller circuitry is further configured to control the charge current based at least in part on an end-of-charge voltage of the plurality of ultracapacitor cells.

8. The ultracapacitor system of claim 7, wherein the controller circuitry is further configured to determine the end-of-charge voltage based at least in part on a detected temperature associated with the ultracapacitor system.

9. The ultracapacitor system of claim 1, wherein the controller circuitry is configured to individually activate each of the plurality of balancing circuits.

10. The ultracapacitor system of claim 9, wherein the controller circuitry is configured to activate one or more of the balancing circuits to lower an overall voltage of the plurality of ultracapacitor cells based at least in part on a detected temperature exceeding a threshold.

11. The ultracapacitor system of claim 9, wherein the controller circuitry is configured to individually activate one or more of the plurality of balancing circuits to implement a cell balancing operation.

12. The ultracapacitor system of claim 11, wherein the cell balancing operation is based at least in part on a lowest cell voltage of a plurality of cell voltages corresponding to the individual ultracapacitor cells.

13. The ultracapacitor system of claim 12, wherein, during the cell balancing operation, the controller circuitry activates the balancing circuits corresponding to each of the ultracapacitor cells having a cell voltage greater than the lowest cell voltage.

14. The ultracapacitor system of claim 12, wherein, during the cell balancing operation, the controller circuitry activates the balancing circuits corresponding to each of the ultracapacitor cells having a cell voltage exceeding the lowest cell voltage by at least a predetermined voltage difference.

15. The ultracapacitor system of claim 11, wherein the cell balancing operation is based at least in part on an average cell voltage of a plurality of cell voltages corresponding to the individual ultracapacitor cells.

16. The ultracapacitor system of claim 15, wherein, during the cell balancing operation, the controller circuitry activates the balancing circuits corresponding to each of the ultracapacitor cells having a cell voltage greater than the average cell voltage.

17. The ultracapacitor system of claim 11, wherein the controller circuitry implements the cell balancing operation in response to a determination that an overall voltage of the plurality of ultracapacitor cells is greater than or equal to a predetermined balancer start voltage.

18. The ultracapacitor system of claim 11, wherein the controller circuitry is configured to implement the cell balancing operation while the charger is charging the plurality of ultracapacitor cells.

19. The ultracapacitor system of claim 18, wherein the controller circuitry implements the cell balancing operation only once per charge cycle of the ultracapacitor system.

20. The ultracapacitor system of claim 1, wherein each balancing circuit comprises a balancing transistor connected in parallel with the corresponding ultracapacitor cell, the balancing transistor having a gate connected to an output of the controller circuitry.

21. The ultracapacitor system of claim 20, wherein each balancing circuit further comprises a discharge resistor connected in series with the balancing transistor.

22. The ultracapacitor system of claim 1, further comprising a redundant transistor electrically connected between the charger and the plurality of ultracapacitor cells, the redundant transistor controllable by the controller circuitry to prevent overcharging of the plurality of ultracapacitor cells.

23. The ultracapacitor system of claim 1, wherein the controller circuitry is configured to transmit monitoring data to a remote computing device via wired or wireless connection for system monitoring.

24. A computer-implemented method of charging an array of ultracapacitor cells, the method comprising:
under control of controller circuitry of an ultracapacitor system:
controlling a charger in communication with the controller circuitry to supply a charge current to a plurality of ultracapacitor cells; and
activating at least one of a plurality of balancing circuits, while the charger supplies the charge current, to implement a cell balancing operation, wherein each of the plurality of balancing circuits is electronically switchable between an activated state in which a corresponding ultracapacitor cell of the plurality of ultracapacitor cells discharges through the balancing circuit and a deactivated state in which the corresponding ultracapacitor cell does not discharge through the balancing circuit.

25. The method of claim 24, wherein controlling the charger comprises causing the charger to charge the plurality of ultracapacitor cells at a constant current.

26. The method of claim 24, wherein controlling the charger comprises causing the charger to charge the plurality of ultracapacitor cells at a constant power.

27. The method of claim 26, wherein the constant power is selected based at least in part on a detected temperature associated with the ultracapacitor system.

28. The method of claim 27, wherein the constant power is derated using a power derating factor when the detected temperature exceeds a predetermined power derating temperature.

29. The method of claim 24, wherein the cell balancing operation is based at least in part on a lowest cell voltage of a plurality of cell voltages corresponding to the individual ultracapacitor cells.

30. The method of claim 29, wherein activating at least one of the balancing circuits comprises activating the balancing circuits corresponding to each of the ultracapacitor cells having a cell voltage greater than the lowest cell voltage.

31. The method of claim 29, wherein activating at least one of the balancing circuits comprises activating the balancing circuits corresponding to each of the ultracapacitor cells having a cell voltage exceeding the lowest cell voltage by at least a predetermined voltage difference.

32. The method of claim 24, wherein the cell balancing operation is based at least in part on an average cell voltage of a plurality of cell voltages corresponding to the individual ultracapacitor cells.

33. The method of claim 32, wherein activating at least one of the balancing circuits comprises activating the balancing circuits corresponding to each of the ultracapacitor cells having a cell voltage greater than the average cell voltage.

34. The method of claim 24, wherein the controller circuitry implements the cell balancing operation in response to a determination that an overall voltage of the plurality of ultracapacitor cells is greater than or equal to a predetermined balancer start voltage.

35. The method of claim 24, wherein the controller circuitry implements the cell balancing operation only once per charge cycle of the ultracapacitor system.
